(19) United States
(12) Patent Application Publication
(10) Pub. No.: US 2015/0369451 A1
(43) Pub. Date: Dec. 24, 2015

(54) LENS ASSEMBLY FOR BACKLIGHT SOURCE AND BACKLIGHT UNIT HAVING THE SAME

(71) Applicant: Samsung Display Co., Ltd., Young-City (KR)

(72) Inventors: Seong-Yong HWANG, Asan-si (KR); Sang Won LEE, Seoul (KR); Joong Hyun KIM, Asan-si (KR); Min-Young SONG, Asan-si (KR); Byung-Seo YOON, Hwaseong-si (KR); Gi Cherl KIM, Suwon-si (KR)

(21) Appl. No.: 14/696,038

(22) Filed: Apr. 24, 2015

(30) Foreign Application Priority Data
Jun. 20, 2014 (KR) 10-2014-0076075

(51) Int. Cl. F21V 5/04; F21V 7/00

(52) U.S. Cl. CPC F21V 5/048; F21V 7/0091; F21Y 2113/005

(57) ABSTRACT

A lens assembly for a backlight light source includes: a plurality of light emitters, where each of the light emitters includes a first light-emitting device and a second light-emitting device, and the first and second light-emitting devices emit light having different colors from each other; and a lens disposed on the light emitter to cover the light emitter, where the lens is substantially symmetric with respect to a center axis thereof and has a bar shape extending in a direction parallel to the center axis, the light emitters are spaced apart from each other in the direction parallel to the center axis, and the first light-emitting device and the second light-emitting device of each of the light emitters are spaced apart from each other in the direction parallel to the center axis.

This application claims priority Korean Patent Application No. 10-2014-0076075 filed on Jun. 20, 2014, and all the benefits accruing therefrom under 35 U.S.C. §119, the contents of which in its entirety is herein incorporated by reference.

### BACKGROUND

(a) Field

The invention relates to a lens assembly for a backlight light source and a backlight unit including the lens assembly.

(b) Description of the Related Art

A liquid crystal display, which is not a self light-emitting device, typically includes a lighting system such as a backlight.

A cold cathode fluorescent lamp (“CCFL”), which has been used for a conventional backlight light-source, consumes high power and has a short lifespan. Accordingly, in recent, backlight systems using light emitting diodes (“LED”s) having a long lifespan with low power consumption and light weight, are widely used to allow the backlight system to be slim.

### SUMMARY

In general, light emitted by a light emitting diode (“LED”) element in a backlight system has linearity, such that intensity of light discharged to a region that is perpendicular to the LED element has the maximum value, and the intensity of light discharged to a region that is not perpendicular to the LED element may have a value less than the maximum value. Therefore, in such a backlight system using the LED element, the intensity of output light is not substantially uniform and may have different intensity depending on the region.

Further, when the LEDs for emitting different colors are used to realize a backlight system for emitting desired colors, the different colors may not be effectively mixed due to the linearity of the LEDs described above.

In the backlight system, gaps between the LED elements may be reduced with increased number of LED elements for increased uniformity of the color light, and manufacturing cost is accordingly increased.

Exemplary embodiments of the invention relate to a lens for a backlight light source for mixing light of different colors substantially effectively without increasing the number of the LED elements, and a backlight unit including the lens.

An exemplary embodiment of the invention provides a lens assembly for a backlight light source, including: a plurality of light emitters, where each of the light emitters includes a first light-emitting device and a second light-emitting device, which emit light having different colors from each other; and a lens disposed on the light emitter to cover the light emitter. In such an embodiment, the lens is substantially symmetric with respect to a center axis and has a bar shape extending in a direction parallel to the center axis, the light emitters are spaced apart from each other in the direction parallel to the center axis, and the first light-emitting device and the second light-emitting device are spaced apart from each other in the direction parallel to the center axis.

In an exemplary embodiment, light emitted by the light emitters to the lens may be totally reflected on an external top surface of the lens, and the totally reflected light may be diffused in a first direction, which is substantially orthogonal to the center axis, through an external side surface of the lens.

In an exemplary embodiment, first light emitted by the first light-emitting device and second light emitted by the second light-emitting device may be diffused in the first direction and mixed with each other.

In an exemplary embodiment, the lens may include two internal side surfaces corresponding to side surfaces of the light emitters and an internal top surface corresponding to a top surface of the light emitters, the internal top surface may include a first slanted surface which allows the lens to be thinner as moving away from the internal side surface to the center axis, and the two internal side surfaces and the internal top surface of the lens may define a shape substantially symmetrical with respect to the center axis.

In an exemplary embodiment, the first slanted surface of the internal top surface may form a first angle with a bottom surface of the lens, and the first angle is in a range of about zero (0) degree to about 45 degrees.

In an exemplary embodiment, the internal top surface of the lens may further include a second slanted surface inclined in a direction which is not substantially parallel to the first slanted surface.

In an exemplary embodiment, the lens may include two external side surfaces corresponding to internal side surfaces thereof, and an external top surface t corresponding to an internal top surface thereof, where the external top surface of the lens may include a second slanted surface which allows a height of the lens to increase as moving away from the center axis to the external top surface, and the two external side surfaces and the external top surface of the lens may define a shape substantially symmetrical with respect to the center axis.

In an exemplary embodiment, the lens has a first thickness on the center axis and becomes thicker as it becomes distant from the center axis, and the first thickness is greater than about 0.5 millimeter (mm).

In an exemplary embodiment, the external top surface of the lens may have a predetermined curvature on the center axis.

In an exemplary embodiment, light emitted by the light emitters may be refracted on the internal top surface, the refracted light may be totally reflected on the external top surface, and the totally reflected light may be diffused in a first direction, which is substantially orthogonal to the center axis, through the external side surface. In such an embodiment, first light emitted by the first light-emitting device and second light emitted by the second light-emitting device may be diffused in the first direction and mixed with each other.

In an exemplary embodiment, the lens may include at least one of a first serration portion defined on the internal top surface, and a second serration portion defined on the external side surface, where each of the first and second serration portions may include a recess portion and a protrusion portion that are alternately disposed with each other.

In an exemplary embodiment, the at least one of the first serration portion and the second serration portion may have a prism form in which a valley and a ridge are alternately disposed.

In an exemplary embodiment, at least one of the valley and the ridge may have a predetermined curvature.

In an exemplary embodiment, the at least one of the first serration portion and the second serration portion may have a form defined by a plurality of hemi-cylinders.

Another embodiment of the invention provides a backlight unit including a plurality of lens assemblies spaced apart from each other in a first direction, where each of the lens assemblies includes a plurality of light emitters, wherein each of the light emitters comprises a first light-emitting device and a second light-emitting device, and the first and second light-emitting devices emit light having different colors from each other, and a lens disposed on the light emitters and to cover the light emitters, where the lens is substantially symmetric with respect to a center axis extending in a second direction, which is substantially orthogonal to the first direction, and has a bar shape extending in the second direction, the light emitters are spaced apart from each other in the second direction, and the first light-emitting device and the second light-emitting device of each of the light emitters are spaced apart from each other in the second direction.

According to exemplary embodiments of the lens assembly for a backlight light source and the backlight unit including the lens assembly according to the invention, the light of different colors are effectively mixed with each other without increasing the number of the light emitters.

### BRIEF DESCRIPTION OF THE DRAWINGS

The above and other features of the invention will become more apparent by describing in further detail exemplary embodiments thereof with reference to the accompanying drawings, in which:

FIG. 1 shows a plan view of an exemplary embodiment of a backlight unit including a lens assembly for a backlight light source, according to the invention;

FIG. 2 shows a perspective view of an exemplary embodiment of a lens assembly of a backlight light source, according to the invention;

FIG. 3 shows a cross-sectional view of an exemplary embodiment of a lens of a lens assembly for a backlight light source, according to the invention;

FIG. 4 shows a schematic view of an exemplary embodiment of a lens assembly for a backlight light source, according to the invention;

FIG. 5 shows a schematic view for describing a path of light passing through a conventional lens assembly for a backlight light source;

FIG. 6 shows a schematic view for describing a path of light passing through an exemplary embodiment of a lens assembly for a backlight light source, according to the invention;

FIG. 7 shows a schematic view for describing mixture of light passing through a conventional lens assembly for a backlight light source;

FIG. 8 shows a schematic view for describing mixture of light passing through an exemplary embodiment of a lens assembly for a backlight light source, according to the invention;

FIG. 9 shows a perspective view of a part of an exemplary embodiment of a backlight unit according to the invention;

FIG. 10 shows a perspective view of a part of an exemplary embodiment of a lens assembly for a backlight light source, according to the invention;

FIG. 11 shows a perspective view of part of a lens assembly for a backlight light source according to the invention;

FIG. 12 to FIG. 14 show perspective views of a serration portion of alternative exemplary embodiments of a lens assembly for a backlight light source, according to the invention;

FIG. 15 and FIG. 16 are graphs showing results from an exemplary experiment;

FIG. 17 shows a cross-sectional view of an alternative exemplary embodiment of a lens of a lens assembly for a backlight light source, according to the invention; and

FIG. 18 shows a cross-sectional view of an alternative exemplary embodiment of a lens of a lens assembly for a backlight light source, according to the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Exemplary embodiments of the invention will now be described with reference to accompanying drawings.

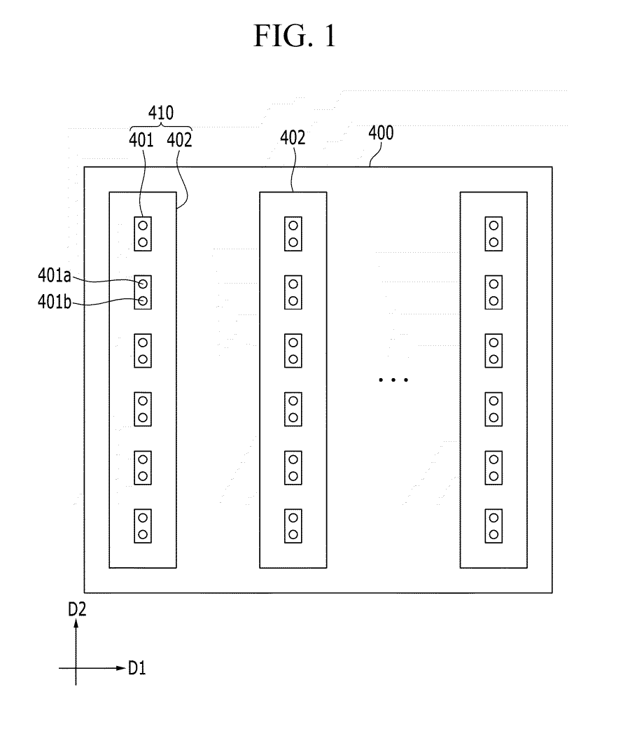

Hereinafter, an exemplary embodiment of a backlight unit including a lens assembly for a backlight light source, according to the invention, will now be described with reference to FIG. 1.

FIG. 1 shows a plan view of an exemplary embodiment of a backlight unit including a lens assembly for a backlight light source, according to the invention.

Referring to FIG. 1, an exemplary embodiment of the backlight unit 400 including a lens assembly for a backlight light source includes a plurality of lens assemblies 410 disposed along a first direction D1 at regular intervals, e.g., with a constant interval. The lens assemblies 410 may extend in a second direction D2 that is orthogonal to the first direction D1.

Each lens assembly 410 includes a plurality of light emitters 401 disposed at regular intervals in a second direction D2, and a lens 402 disposed on the light emitters 401 to cover the light emitters 401 and extending in the second direction D2 to have a bar shape. Each light emitter 401 includes a first light-emitting device 401a and a second light-emitting device 401b, which are spaced apart from each other in the second direction D2.

The first light-emitting device 401a and the second light-emitting device 401b emit light having different colors from each other. The first light-emitting device 401a and the second light-emitting device 401b may emit one of three primary colors, e.g., red, green and blue, or magenta, green and cyan. In such an embodiment, the first light-emitting device 401a and the second light-emitting device 401b may include a light emitting diode (“LED”).

In an exemplary embodiment, as described above, each of the light emitters 401 includes a first light-emitting device 401a and a second light-emitting device 401b for expressing different colors, but the invention is not limited thereto. In an alternative exemplary embodiment, and each of the light emitters 401 may include three or more light-emitting devices for expressing different colors, in which the three or more light-emitting devices that express different colors are spaced apart from each other and are disposed in a direction in which the lens 402 is provided.

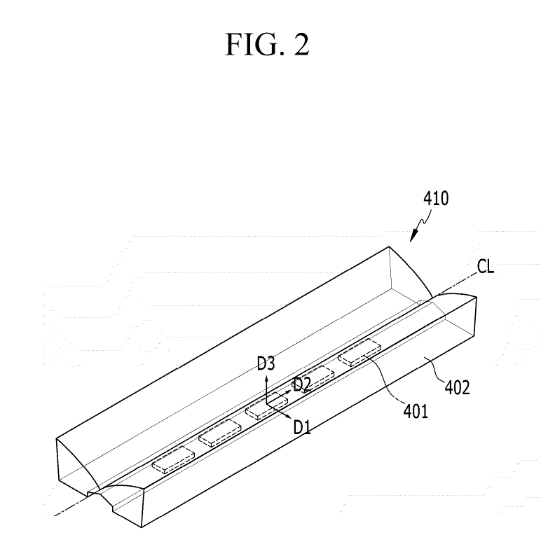

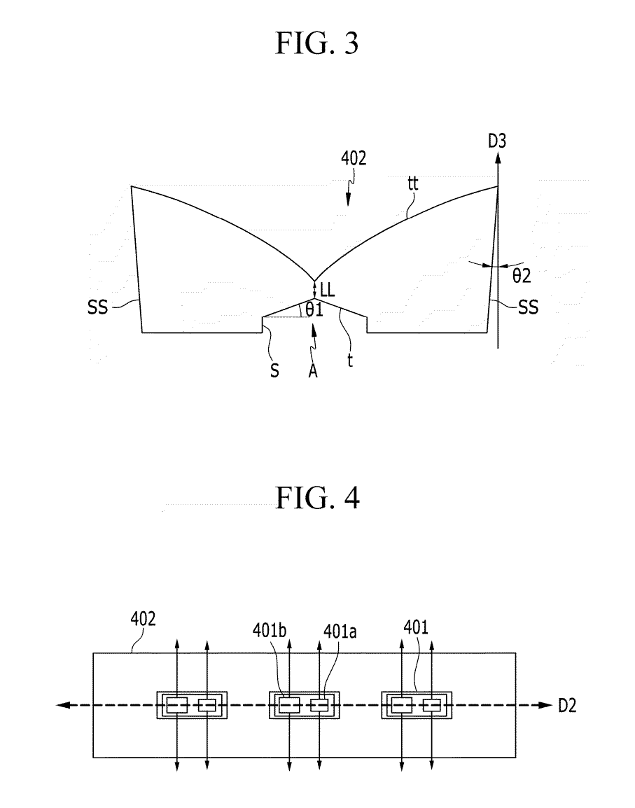

An exemplary embodiment of a lens assembly 410 for a backlight light source according to the invention will now be described in greater detail with reference to FIG. 2 and FIG. 3. FIG. 2 shows a perspective view of an exemplary embodiment of a lens assembly of a backlight light source, according to the invention, and FIG. 3 shows a cross-sectional view of an exemplary embodiment of a lens of a lens assembly for a backlight light source, according to the invention.

Referring to FIG. 2 and FIG. 3, an exemplary embodiment of the lens assembly 410 for a backlight light source includes a plurality of light emitters 401 disposed at regular intervals along the second direction D2, and a lens 402 disposed on the light emitters 401 to cover the light emitters 401 and extending in the second direction D2 to have a bar shape.

The lens 402 has a groove (A) that allows the light emitters 401 to be disposed at a lower portion thereof.

Referring to FIG. 3, by the groove (A) defined at the lower portion of the lens 402, an internal surface of the lens 402 includes two internal side surfaces (S) that correspond to a side surface of the light emitters 401, and an internal top surface (t) that corresponds to a top portion surface of the light emitters 401. The two internal side surfaces (S) and the internal top surface (t) are substantially symmetrical to each other in a direction that is parallel to the first direction D1 with respect to a center axis (CL) extending in the second direction D2. In such an embodiment, the two internal side surfaces (S) and the internal top surface (t) may define a shape substantially symmetrical with respect to the center axis (CL).

In an exemplary embodiment, the internal top surface (t) of the lens 402 may have a slanted surface form such that the groove (A) may become higher toward the center axis (CL) from the internal side surface (s). In such an embodiment, the internal top surface (t) of the lens 402 has a slanted surface form such that the lens 402 may become thinner toward the center axis (CL) from the internal side surface (S). The slanted surface of the internal top surface (t) of the lens 402 forms a first angle (01) with a bottom surface of the lower portion of the lens 402. The first angle (01) may be in a range of about zero (0) degree to about 45 degrees.

An external surface of the lens 402 includes two external side surfaces (SS) and an external top surface (tt). The external side surface (SS) of the lens 402 has a second angle (01) with respect to the third direction D3 that is perpendicular to the first direction D1 and the second direction D2. The external top surface (tt) of the lens 402 is formed to have a slanted surface so that it may become higher as it approaches the external side surface (SS) from the center axis (CL).

According to an exemplary embodiment, as described above, the lens 402 may have a first thickness H1 that is a minimum thickness from the center axis (CL), and the lens 402 may have a thickness that increases as being away from the center axis (CL). The first thickness H1 may be greater than about 0.5 millimeters (mm).

An exemplary embodiment of the lens assembly 410 for a backlight light source according to the invention includes a plurality of light emitters 401 disposed at regular intervals in the second direction D2, and a lens 402 disposed on the light emitters 401 to cover the light emitters 401, extending in the second direction D2 to have a bar shape, and having a thickness increasing as being away from the center axis. In such an embodiment, light emitted from the light emitters 401 is diffused by the lens 402 mainly in the first direction D1 that is orthogonal to the second direction D2, which will be described later in greater detail.

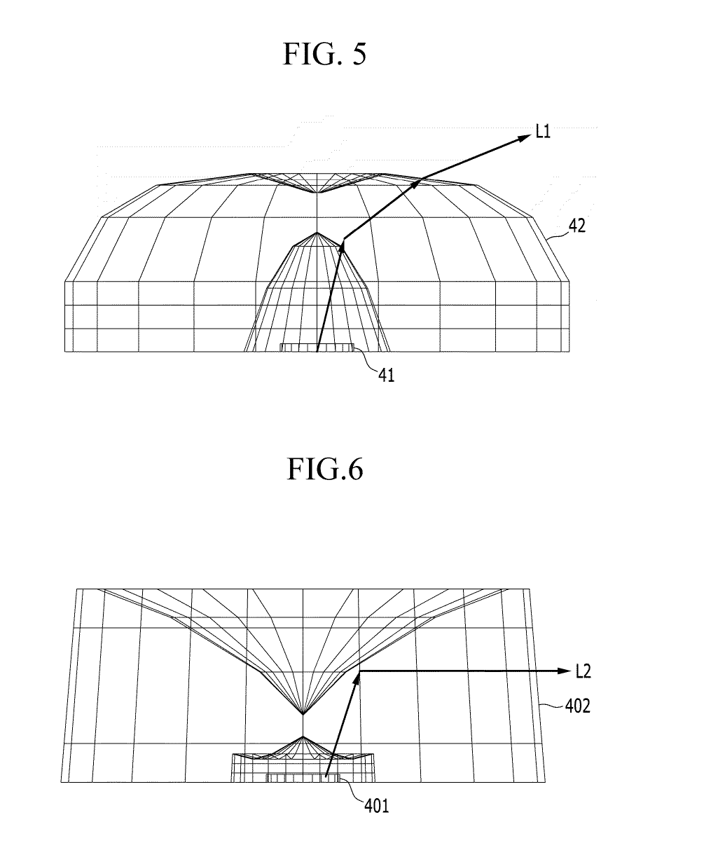

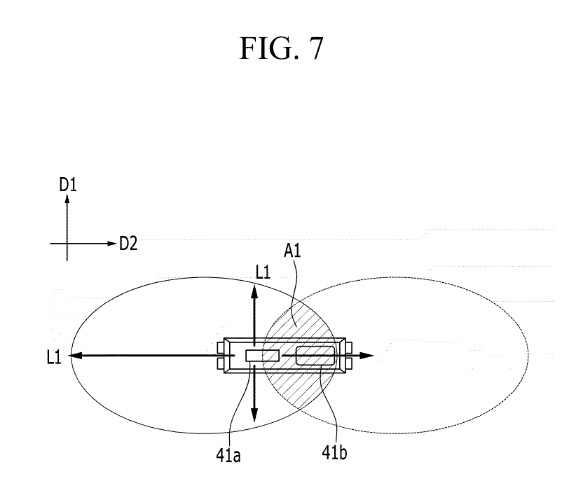

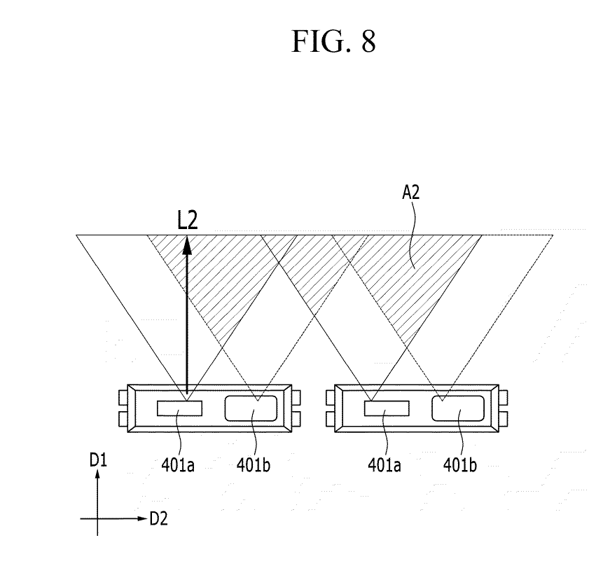

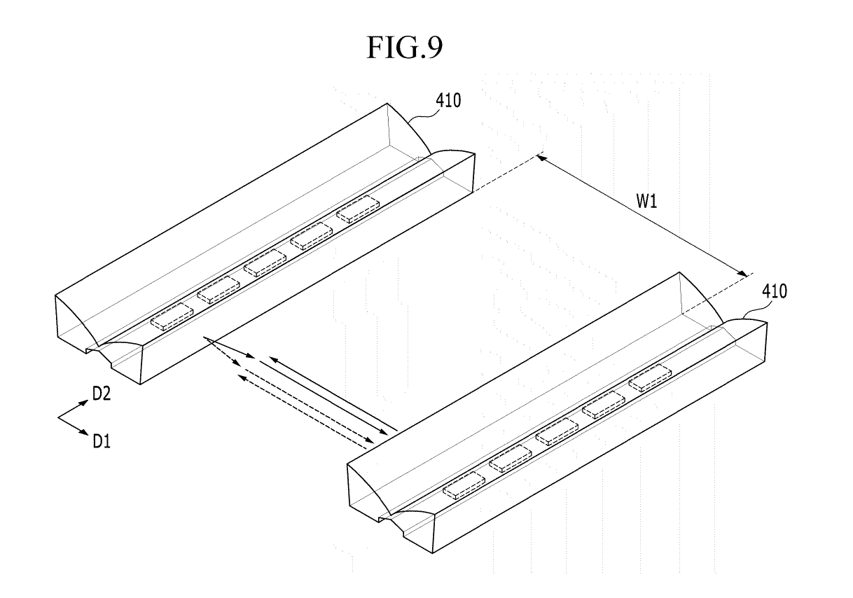

A path of light passing through an exemplary embodiment of a lens assembly for a backlight light source according to the invention will now be described with reference to FIG. 5 to FIG. 9. FIG. 5 shows a schematic view for describing a path of light passing through a conventional lens assembly for a backlight light source, and FIG. 6 shows a schematic view for describing a path of light passing through an exemplary embodiment of a lens assembly for a backlight light source according to the invention. FIG. 7 shows a schematic view for describing mixture of light passing through a conventional lens assembly for a backlight light, and FIG. 8 shows a schematic view for describing mixture of light passing through an exemplary embodiment of a lens assembly for a backlight light source according to the invention. FIG. 9 shows a perspective view of part of an exemplary embodiment of a backlight unit according to the invention.

Referring to FIG. 5, the lens 42 of the conventional lens assembly for a backlight light source is provided on the light-emitting device 41 to cover the light-emitting device. As shown in FIG. 5, the lens 42 of the conventional lens assembly may be concave in the center, and become more convex as it approaches the edge thereof.

Referring to FIG. 5 and FIG. 7, the light L1 emitted by the light-emitting device 41 passes through the lens 42, and the light L1 is refracted on an internal surface of the lens 42, again refracted on an external surface of the lens 42 and then spread in a direction with a predetermined angle with respect to a surface of the lens 42. Therefore, the light L1 is spread out in the first direction D1, the second direction D2, and the third direction D3 along the surface of the lens 42 such that the light L1 is spread out in a circular or oval manner with respect to the light-emitting device 41.

As described, while passing through the lens 42 of the conventional lens assembly for a backlight light source, the light emitted by a third light-emitting device 41a and a fourth light-emitting device 41b for emitting different light is spread out in a circular or oval manner with respect to the light-emitting devices 41a and 41b, the light emitted by the third light-emitting device 41a and the fourth light-emitting device 41b may not be effectively mixed, and an area of a first region A1 in which light emitted by the third light-emitting device 41a is mixed with light emitted by the fourth light-emitting device 41b is small. Therefore, in such a backlight source including the conventional lens assembly, the light-emitting devices may be disposed to be near each other and the number of light-emitting devices may be increased, to effectively mix the light emitted by the light-emitting devices 41a and 41b for emitting different colors of light.

Referring to FIGS. 3, 6 and 8, the light L2 emitted by the light emitters 401 (e.g., one of the first light-emitting device 401a and the second light-emitting device 401b) of an exemplary embodiment of the lens assembly for a backlight light source, according to the invention, is refracted on the internal surface of the lens 402 corresponding to (e.g., facing) a top surface of the light emitters 401, totally reflected at the external top surface (tt), and spread out in a direction that is orthogonal to the center axis (CL), that is, the first direction D1, through the external side surface (SS) opposite to the internal side surface (S) corresponding to (e.g., facing) a side surface of the light emitters 401.

Therefore, as shown in FIG. 8, the light emitted by the first light-emitting device 401a and the second light-emitting device 401b for emitting different light is totally reflected and diffused in the first direction D1 such that an area of a second region A2, in which the light emitted by the first light-emitting device 401a is mixed with the light emitted by the second light-emitting device 401b, is increased. In such an embodiment, the light emitted by the first light-emitting device 401a and the second light-emitting device 401b is further spread out in the first direction D1.

As described above, in an exemplary embodiment, the light emitted by the light emitters 401 is diffused in the first direction D1 that is a horizontal direction, when a gap W1 between the lens assemblies 410 is widened as shown in FIG. 9, such that light is emitted in the wide area. Accordingly, the backlight light source for emitting light mixed with a plurality of colors may be effectively realized without increasing the number of the light emitters 401.

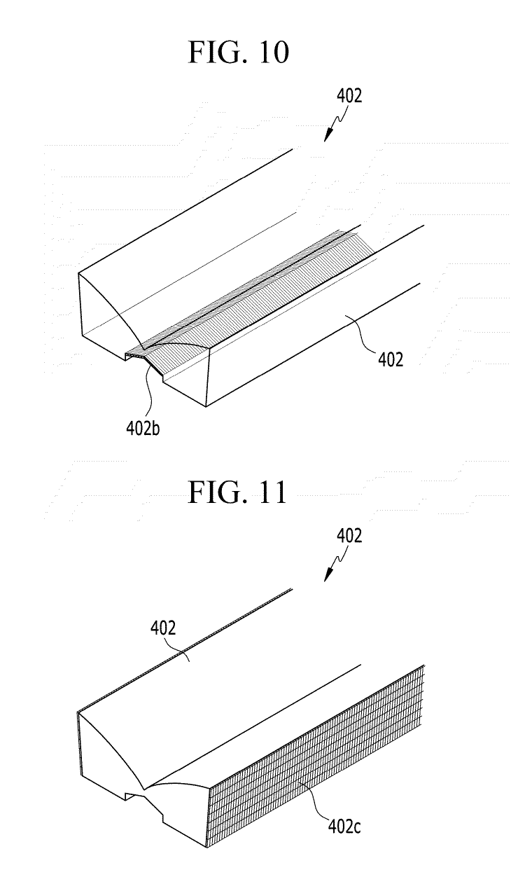

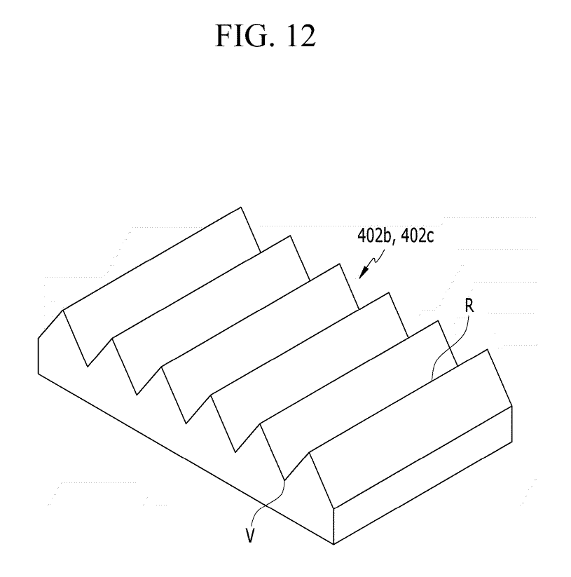

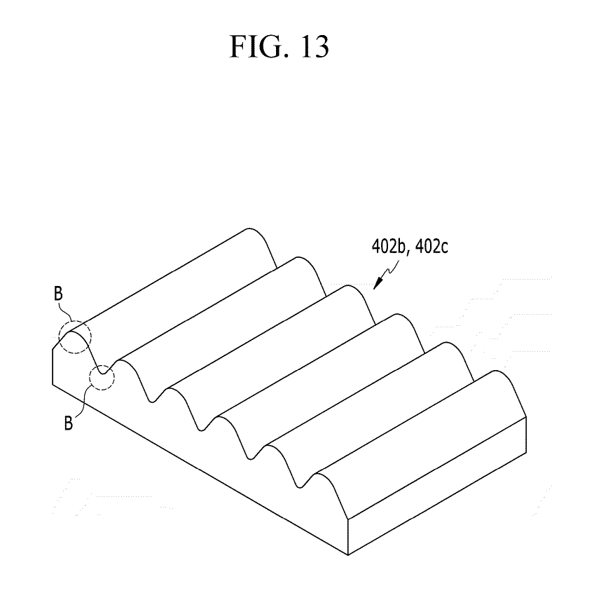

An alternative exemplary embodiment of a lens assembly for a backlight light source, according to the invention, will now be described with reference to FIG. 10 and FIG. 12 to FIG. 14. FIG. 10 shows a perspective view of a part of an exemplary embodiment of a lens assembly for a backlight light source, according to the invention. FIG. 12 to FIG. 14 show perspective views of a serration portion of exemplary embodiments of a lens assembly for a backlight light source, according to the invention.

Exemplary embodiments of a lens assembly for a backlight light source shown in FIG. 10 and FIGS. 12 to 14 are substantially the same as exemplary embodiments of a lens assembly for a backlight light source described above with reference to FIGS. 1 to 3 except for a serration portion 402b defined on a surface of the lens 402, and any repetitive detailed description thereof will hereinafter be omitted or simplified.

Referring to FIG. 10, in an exemplary embodiment, a first serration portion 402b is defined on the internal surface of the lens 402 of the lens assembly 410 for a backlight light source. In such an embodiment, first serration portion 402b has a recess portion and a protrusion portion. In such an embodiment, as shown in FIGS. 12 to 14, the recess portion and the protrusion portion of the first serration portion 402b may be alternately and repeatedly disposed in the second direction D2, in which the lens 402 extends. In such an embodiment, a distance between adjacent recess portions and a distance between adjacent protrusion portions may be substantially the same as each other.

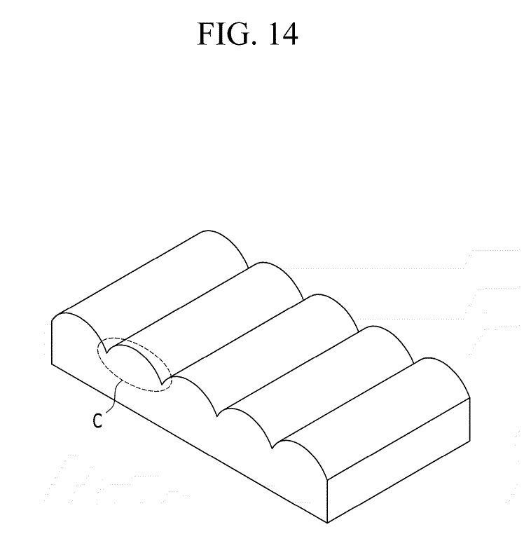

In an exemplary embodiment, as shown in FIG. 12, the recess portion and the protrusion portion of a serration portion 402b (hereinafter a first serration portion) may define a prism-like shape, in which a valley (V) and a ridge (R) are alternately disposed. In an alternative exemplary embodiment, as shown in FIG. 13, the recess portion and the protrusion portion of the first serration portion 402b may define a prism-like shape, in which the valley and the ridge are alternately disposed, and the valley and the ridge may have a predetermined curvature (B). In such an embodiment, as shown in FIG. 13, both of the valley and the ridge of the first serration portion 402b may have a predetermined curvature, but not being limited thereto. In another alternative exemplary embodiment of the invention, one of the valley and the ridge of the first serration portion 402b may have a predetermined curvature. In such an embodiment, as shown in FIG. 14, the first serration portion 402b may have a shape in which a plurality of hemi-cylinders (C) is arranged in the second direction D2, and the hemi-cylinders (C) may extend in a direction substantially parallel to the second direction D2.

In such an embodiment, the first serration portion 402b may have a pitch in a range of about 100 micrometers (μm) to about 500 μm, and a height in a range of about 80 μm to about 120 μm. An angle between a virtual line extending to the adjacent valley of the first serration portion 402b and a slanted surface between the valley and the ridge of the first serration portion 402b may be in a range of about 10 degrees to about 60 degrees.

Another alternative exemplary embodiment of a lens assembly for a backlight light source, according to the invention, will now be described with reference to FIG. 11 and FIG. 12 to FIG. 14. FIG. 11 shows a perspective view of a part of an exemplary embodiment of a lens assembly for a backlight light source according to the invention.

Exemplary embodiments of a lens assembly for a backlight light source shown in FIG. 11 are substantially the same as exemplary embodiments of a lens assembly for a backlight light source described above with reference to FIG. 10 except that a serration portion 402c is defined on an external surface of the lens 402, and any repetitive detailed description thereof will hereinafter be omitted or simplified.

Referring to FIG. 11, in an alternative exemplary embodiment, a serration portion 402c (hereinafter, a second serration portion) is defined on an external side surface (SS) of the external surface of the lens 402 of the lens assembly 410. In such an embodiment, the recess portion and the protrusion portion of the second serration portion 402c may be alternately and repeatedly disposed in the second direction D2.

In such an embodiment, as shown in FIG. 12, the recess portion and the protrusion portion of the second serration portion 402c can have a prism form in which a valley (V) and a ridge (R) are alternately disposed. Alternatively, as shown in FIG. 13, the recess portion and the protrusion portion of the second serration portion 402c have a prism form in which the valley and the ridge are alternately disposed, and the valley and the ridge can have a predetermined curvature (B). In such an embodiment, as shown in FIG. 13, it has been described that the valley and the ridge of the second serration portion 402c have a predetermined curvature, but not being limited thereto. In such an embodiment of the invention, one of the valley and the ridge of the second serration portion 402c may have a predetermined curvature. Referring to FIG. 14, in an alternative exemplary embodiment, the second serration portion 402c may have a form in which a plurality of hemi-cylinders (C) is arranged in the second direction D2, and the hemi-cylinders (C) may extend in a direction substantially parallel to the second direction D2.

In such an embodiment, the second serration portion 402c may have a pitch in a range of about 100 μm to about 500 μm, and a height in a range of about 80 μm to about 120 μm. An angle between a virtual line extending to the adjacent valley of the second serration portion 402c and a slanted surface between the valley and the ridge of the first serration portion 402b may be in a range of about 10 degrees to about 60 degrees.

In an alternative exemplary embodiment, both of the first serration portion 402b and the second serration portion 402c may be defined on the internal surface and the external surface of the lens 402 of the lens assembly 410, respectively.

In such embodiment, the first serration portion 402b or the second serration portion 402c allow the light emitted by the light emitters 401 (e.g., one of the first light-emitting device 401a and the second light-emitting device 401b) to be substantially uniformly diffused.

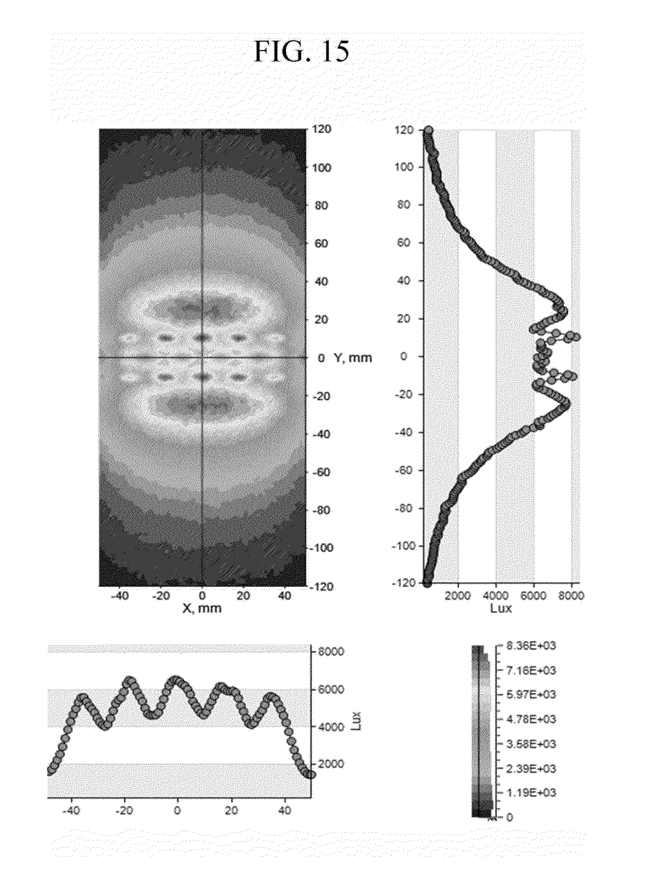

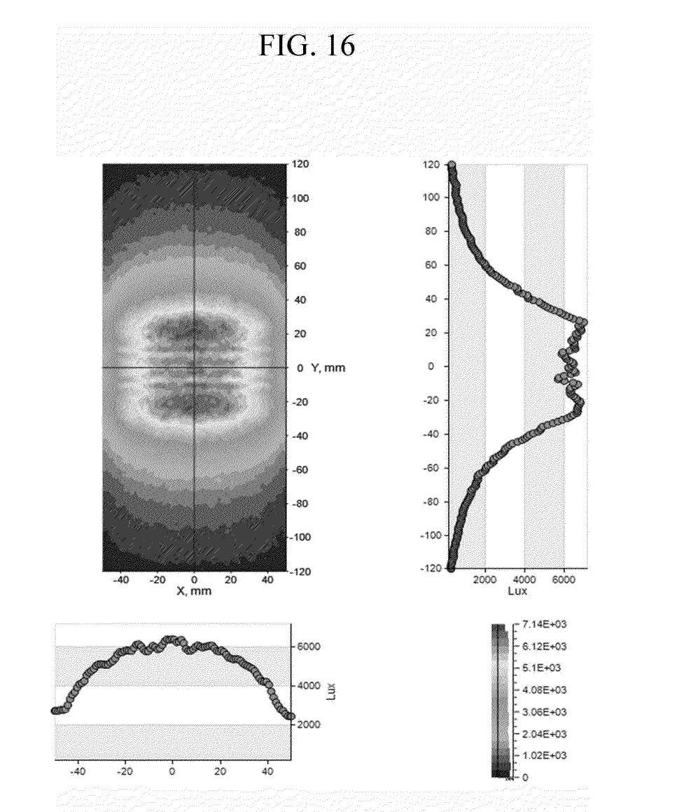

Exemplary embodiments including the first serration portion 402b or the second serration portion 402c will now be described with reference to FIG. 15 and FIG. 16. FIG. 15 and FIG. 16 are graphs showing results from an exemplary experiment.

Such an exemplary experiment is performed by measuring intensity of light emitted by the light-emitting device for a first case in which no serration portion is provided on the lens provided on the light-emitting device and intensity of light emitted by the light-emitting device for a second case in which the serration portion is formed on the lens, and corresponding results are shown in FIG. 15 and FIG. 16. FIG. 15 shows a result for the first case and FIG. 16 shows a result for the second case.

Referring to FIG. 15 and FIG. 16, the intensity of the light emitted by the light-emitting device is the greatest in a central region in which the light-emitting device is provided and the intensity of the light is decreased as being distant from the center portion, and in the second case in which the serration portion is provided on the lens, the intensity of the light emitted by the light-emitting device has a substantially uniform value in the central region. However, in the first case in which the serration portion is not provided on the lens, a region in which intensity of the light emitted by the light-emitting device is relatively strong and a region in which the intensity of the light is relatively weak exist in the central region. Therefore, in the second case in which the serration portion is provided on the lens, uniformity of the light emitted by the light-emitting device is substantially improved compared to the first case in which the serration portion is not provided on the lens.

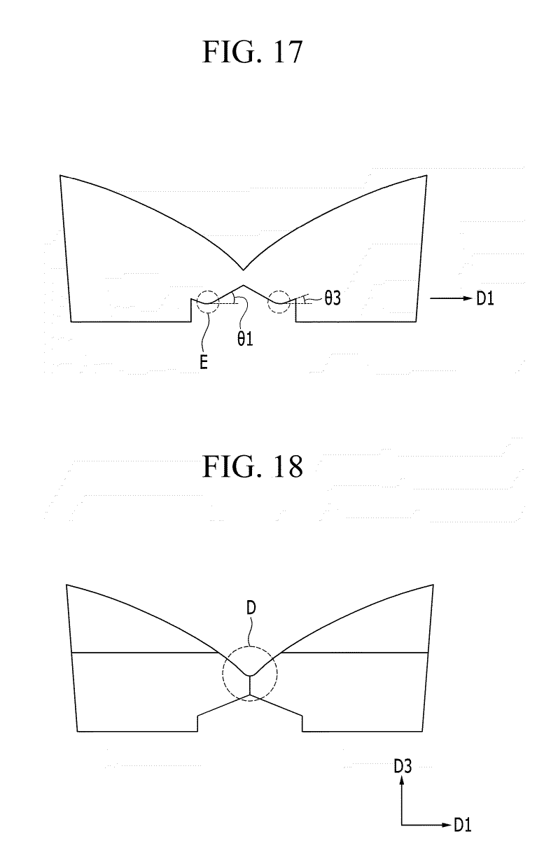

An alternative exemplary embodiment of a lens assembly for a backlight light source according to the invention will now be described with reference to FIG. 17. FIG. 17 shows a cross-sectional view of an alternative exemplary embodiment of a lens of a lens assembly for a backlight light source, according to the invention.

The lens of the lens assembly for a backlight light source shown in FIG. 17 is substantially the same as the lens 402 shown in FIG. 3 except for an internal surface thereof. The same or like elements shown in FIG. 13 have been labeled with the same reference characters as used above to describe the exemplary embodiments of the lens 402 shown in FIG. 3, and any repetitive detailed description thereof will hereinafter be omitted or simplified.

In an exemplary embodiment, as shown in FIG. 17, an internal surface of the lens includes a first slanted surface (S1) having a first angle (01) with respect to the first direction D1, and a second slanted surface (S2) between the first slanted surface (S1) and the internal side surface (s), configured to increase a height of a groove (A) when approaching to the internal side surface (s), and having a third angle (03) with respect to the first direction D1. In such an embodiment, the first angle (01) may be different from the third angle (03). Since the internal surface of the lens includes a plurality of slanted surfaces as described above, the refracted angle of the light emitted by the light-emitting device may be further varied such that the spreading direction of the light emitted by the light-emitting device is controllable.

Many characteristic of the exemplary embodiments of the lens assembly for a backlight light source described above are applicable to such an embodiment of the lens assembly for a backlight light source.

Another alternative exemplary embodiment of a lens assembly for a backlight light source according to the invention will now be described with reference to FIG. 18. FIG. 18 shows a cross-sectional view of another alternative exemplary embodiment of a lens of a lens assembly for a backlight light source, according to the invention.

The lens of the lens assembly for a backlight light source shown in FIG. 18 is substantially the same as the lens 402 shown in FIG. 3 except for a center portion thereof. The same or like elements shown in FIG. 13 have been labeled with the same reference characters as used above to describe the exemplary embodiments of the lens 402 shown in FIG. 3, and any repetitive detailed description thereof will hereinafter be omitted or simplified.

In an exemplary embodiment, as shown in FIG. 18, a curved portion (D) having a predetermined curvature is defined on the center axis (CL) of the lens 402. In such an embodiment, no light is refracted on the curved portion (D), such that the light emitted by the light-emitting device may emit in the third direction D3. In such an embodiment, the curvature of the curved portion (D) may be less than about 0.5 millimeters (mm).

In an exemplary embodiment, as described, the spreading direction of the light emitted by the light-emitting device may be controlled by providing the curved portion (D) having a predetermined curvature on the center axis (CL) of the lens 402.

Many characteristic of the exemplary embodiments of the lens assembly for a backlight light source described above are applicable to such an embodiment of the lens assembly for a backlight light source.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A lens assembly for a backlight light source, comprising:
a plurality of light emitters, wherein each of the light emitters comprises a first light-emitting device and a second light-emitting device, and the first and second light-emitting devices emit light having different colors from each other; and
a lens disposed on the light emitters to cover the light emitters,
wherein
the lens is substantially symmetric with respect to a center axis thereof and has a bar shape extending in a direction parallel to the center axis,
the light emitters are spaced apart from each other in the direction parallel to the center axis, and
the first light-emitting device and the second light-emitting device of each of the light emitters are spaced apart from each other in the direction parallel to the center axis.

2. The lens assembly of claim 1, wherein
light emitted by the light emitters to the lens is totally reflected on an external top surface of the lens,
the totally reflected light is diffused in a first direction, which is substantially orthogonal to the center axis, through an external side surface of the lens, and
first light emitted by the first light-emitting device and second light emitted by the second light-emitting device are diffused in the first direction and are mixed with each other.

3. The lens assembly of claim 2, wherein
the lens includes two internal side surface corresponding to side surfaces of the light emitters and an internal top surface corresponding to a top surface of the light emitters,
the internal top surface of the lens includes a first slanted surface which allows the lens to be thinner as moving away from the internal side surface to the center axis, and
the two internal side surfaces and the internal top surface of the lens define a shape substantially symmetrical with respect to the center axis.

4. The lens assembly of claim 3, wherein
the first slanted surface of the internal top surface forms a first angle with a bottom surface of the lens, and
the first angle is in a range of about zero (0) degree to about 45 degrees.

5. The lens assembly of claim 3, wherein
the internal top surface of the lens further includes a second slanted surface inclined in a direction which is not substantially parallel to the first slanted surface.

6. The lens assembly of claim 3, wherein
the lens includes two external side surfaces corresponding to internal side surfaces thereof, and an external top surface corresponding to an internal top surface thereof,
the external top surface of the lens includes a third slanted surface which allows a height of the lens to increase as moving away from the center axis to the external side surface, and
the two external side surfaces and the external top surface of the lens define a shape substantially symmetrical with respect to the center axis.

7. The lens assembly of claim 6, wherein
the lens has a first thickness at the center axis and becomes thicker as moving away from the center axis, and
the first thickness is greater than about 0.5 millimeter.

8. The lens assembly of claim 7, wherein
the external top surface of the lens has a predetermined curvature on the center axis.

9. The lens assembly of claim 6, wherein
the lens includes at least one of a first serration portion defined on the internal top surface, and a second serration portion is defined on the two external side surfaces, and
each of the first and second serration portions comprises a recess portion and a protrusion portion, which are alternately disposed with each other.

10. The lens assembly of claim 9, wherein
the at least one of the first serration portion and the second serration portion has a prism shape in which a valley and a ridge are alternately disposed.

11. A backlight unit comprising:
a plurality of lens assemblies spaced apart from each other in a first direction,
wherein each of the lens assemblies comprises:
a plurality of light emitters, wherein each of the light emitters comprises a first light-emitting device and a second light-emitting device, and the first and second light-emitting devices emit light having different colors from each other, and
a lens disposed on the light emitters and to cover the light emitters, wherein
the lens is substantially symmetric with respect to a center axis extending in a second direction, which is substantially orthogonal to the first direction, and has a bar shape extending in the second direction,
the light emitters are spaced apart from each other in the second direction, and
the first light-emitting device and the second light-emitting device of each of the light emitters are spaced apart from each other in the second direction.

12. The backlight unit of claim 11, wherein
light emitted by the light emitters to the lens is totally reflected on an external top surface of the lens,
the totally reflected light is diffused in the first direction through an external side surface of the lens, and
first light emitted by the first light-emitting device and second light emitted by the second light-emitting device are diffused in the first direction and are mixed with each other.

13. The backlight unit of claim 12, wherein
the lens includes two internal side surfaces corresponding to side surfaces of the light emitters and an internal top surface corresponding to a top surface of the light emitters,
the internal top surface of the lens includes a first slanted surface which allows the lens to be thinner as moving away from the internal side surface to the center axis, and
the two internal side surfaces and the internal top surface of the lens define a shape substantially symmetrical with respect to the center axis.

14. The backlight unit of claim 13, wherein
the first slanted surface of the internal top surface forms a first angle with a bottom surface of the lens, and
the first angle is in a range of about zero (0) degree to about 45 degrees.

5. The backlight unit of claim 13, wherein
the internal top surface of the lens further includes a second slanted surface inclined in a direction which is not substantially parallel to the first slanted surface.

16. The backlight unit of claim 13, wherein
the lens further includes two external side surfaces corresponding to the two internal side surfaces thereof, and an external top surface corresponding to the internal top surface thereof,
the external top surface includes a third slanted surface which allows the lens to be higher as moving away from the center axis to the external top surface, and
the two external side surfaces and the external top surface of the lens define a shape substantially symmetrical with respect to the center axis.

17. The backlight unit of claim 13, wherein
the lens has a first thickness on the center axis and becomes thicker as moving away from the center axis, and
the first thickness is greater than about 0.5 millimeter.

18. The backlight unit of claim 17, wherein
the external top surface of the lens has a predetermined curvature on the center axis.

19. The backlight unit of claim 16, wherein
the lens includes at least one of a first serration portion defined on the internal top surface, and a second serration portion defined on the external side surface, and
each of the first and second serration portions comprises a recess portion and a protrusion portion which are alternately disposed with each other.

20. The backlight unit of claim 19, wherein
the at least one of the first serration portion and the second serration portion has a prism form in which a valley and a ridge are alternately disposed.
